(19) United States
(12) Patent Application Publication
(10) Pub. No.: US 2014/0112276 A1
(43) Pub. Date: Apr. 24, 2014

(54) METHOD AND APPARATUS FOR PERFORMING A RANDOM ACCESS PROCESS

(71) Applicants: Joon Kui Ahn, Anyang-si (KR); Dong Youn Seo, Anyang-si (KR); Suck Chel Yang, Anyang-si (KR); Min Gyu Kim, Anyang-si (KR)

(72) Inventors: Joon Kui Ahn, Anyang-si (KR); Dong Youn Seo, Anyang-si (KR); Suck Chel Yang, Anyang-si (KR); Min Gyu Kim, Anyang-si (KR)

(73) Assignee: LG ELECTRONICS INC., Seoul (KR)

(21) Appl. No.: 14/113,974

(22) PCT Filed: Apr. 30, 2012
(86) PCT No.: PCT/KR2012/003358

§ 371 Date: Dec. 2, 2013

Related U.S. Application Data
(60) Provisional application No. 61/479,851, filed on Apr. 28, 2011.
(60) Provisional application No. 61/500,104, filed on Jun. 22, 2011.
(60) Provisional application No. 61/511,982, filed on Jul. 26, 2011.
(60) Provisional application No. 61/512,372, filed on Jul. 27, 2011.
(60) Provisional application No. 61/521,381, filed on Aug. 9, 2011.

(51) Int. Cl. H04W 74/08

(52) U.S. Cl. CPC H04W 74/0833
USPC 370/329

(57) ABSTRACT

Disclosed are a method and apparatus for performing a random access process in a wireless communication system. A terminal transmits a random access preamble in a first serving cell, and monitors a control channel for receiving a random access response for said random access preamble in a second serving cell. Proposed is a method is in which random access is performed when a plurality of serving cells are set up.

### CROSS-REFERENCE TO RELATED APPLICATIONS

This application claims the benefit of priority of U.S. Provisional applications No. 61/479,851 filed on Apr. 28, 2011, No. 61/500,104 filed on Jun. 22, 2011, No. 61/511,982 filed on Jul. 26, 2011, No. 61/512,372 filed on Jul. 27, 2011, and No. 61/521,381 filed on Aug. 9, 2011, of which are incorporated by reference in their entirety herein.

### TECHNICAL FIELD

The present invention relates to wireless communication and more particularly, a method and an apparatus for performing random access in a wireless communication system.

### BACKGROUND ART

LTE (Long Term Evolution) is a standard for the next generation mobile communication based on the 3GPP (3^{rd} Generation Partnership Project) TS (Technical Specification) Release 8.

As disclosed in the 3GPP TS 36.211 V8.7.0 (2009-05) “Evolved Universal Terrestrial Radio Access (E-UTRA): Physical Channels and Modulation (Release 8)”, the physical channels defined in the 3GPP LTE can be further divided into downlink channels and uplink channels, where PDSCH (Physical Downlink Shared Channel) and PDCCH (Physical Downlink Control Channel) are defined for the downlink channels while PUSCH (Physical Uplink Shared Channel) and PUCCH (Physical Uplink Control Channel) are defined for the uplink channels.

To reduce interference among a plurality of user equipment (UE) due to uplink transmission, it is important for a base station to maintain uplink time alignment of each UE. A UE can be located anywhere within a cell; thus, the time required for an uplink signal transmitted by a UE to reach the corresponding base station varies depending on a current position of the user equipment. For instance, the arrival time for a signal transmitted by a UE located at the edge of the cell is longer than the arrival time for a signal transmitted by a UE located in the center of the cell. Contrarily, the arrival time for a signal transmitted by a UE located at the edge of the cell is shorter than the arrival time for a signal transmitted by a UE located in the center of the cell.

To reduce interference among UEs, the base station is also required to perform scheduling for uplink signals transmitted by the UEs within the cell to be received within the respective time boundaries. The base station has to adjust transmission timings of the UEs appropriately depending on the situation of each individual UE. Such adjustment is called uplink time alignment. A random access process is one of processes intended for maintaining uplink time alignment.

These days, a plurality of serving cells is introduced to provide a much higher data rate. The existing uplink time alignment or the random access process has been designed by taking account of only a single serving cell.

### DISCLOSURE OF THE INVENTION

The present invention has been made in an effort to provide a method and an apparatus for performing random access by taking account of a plurality of serving cells.

The present invention has been made in an effort to provide a method and an apparatus for adjusting uplink time alignment by taking account of a plurality of serving cells.

In one aspect, there is provided a method for performing a random access process random access procedure in a wireless communication system. The method may comprise: transmitting a random access preamble for a first serving cell; monitoring a control channel for receiving a random access response with respect to the random access preamble via a second serving cell; and receiving the random access response with respect to the random access preamble from the second serving cell.

While the control channel is being monitored, a transmission of a random access preamble to the second serving cell may be prohibited

The method may further comprise: suspending monitoring the control channel to transmit a random access preamble to the second serving cell while the control channel is being monitored.

In other aspect, there is provided an apparatus for performing a random access procedure in a wireless communication system. The apparatus may comprise an RF (Radio Frequency) unit transmitting and receiving radio signals; and a processor connected to the RF unit and configured to instruct the RF unit to transmit a random access preamble for a first serving cell, monitor a control channel for receiving a random access response with respect to the random access preamble via a second serving cell and receive the random access response with respect to the random access preamble from the second serving cell.

The present invention provides a method for performing random access while a plurality of serving cells is employed. According to the present invention, uplink time alignment for each of the plurality of serving cells can be adjusted.

### BRIEF DESCRIPTION OF THE DRAWINGS

The accompany drawings, which are included to provide a further understanding of the present invention and constitute a part of specifications of the present invention, illustrate embodiments of the present invention and together with the description serve to explain the principles of the present invention.

FIG. 1 illustrates the structure of a downlink radio frame in the 3GPP LTE;

FIG. 2 illustrates one example of multiple carrier waves;

FIG. 3 illustrates one example of cross-CC scheduling;

FIG. 4 illustrates the structure of MAC PDU in the 3GPP LTE;

FIG. 5 illustrates various examples of MAC sub-header;

FIG. 6 illustrates TAC MAC CE;

FIG. 7 illustrates a difference of UL propagation in a plurality of serving cells;

FIG. 8 illustrates examples of TAC MAC CE according to one embodiment of the present invention;

FIG. 9 illustrates a random access process according to one embodiment of the present invention;

FIG. 10 illustrates one example of performing a random access process; and

FIG. 11 illustrates a block diagram of a wireless communication system in which an embodiment of the present invention is implemented.

### MODES FOR CARRYING OUT THE PREFERRED EMBODIMENTS

A user equipment (UE) may be fixed or mobile, and can be called by different names such as mobile station (MS), mobile terminal (MT), user terminal (UT), subscriber station (SS), wireless device, personal digital assistant (PDA), wireless modem, handheld device, and many more.

A base station usually refers to a fixed station communicating with the UE, and can be called differently as evolved-NodeB (eNB), base transceiver system (BTS), access point, and so on.

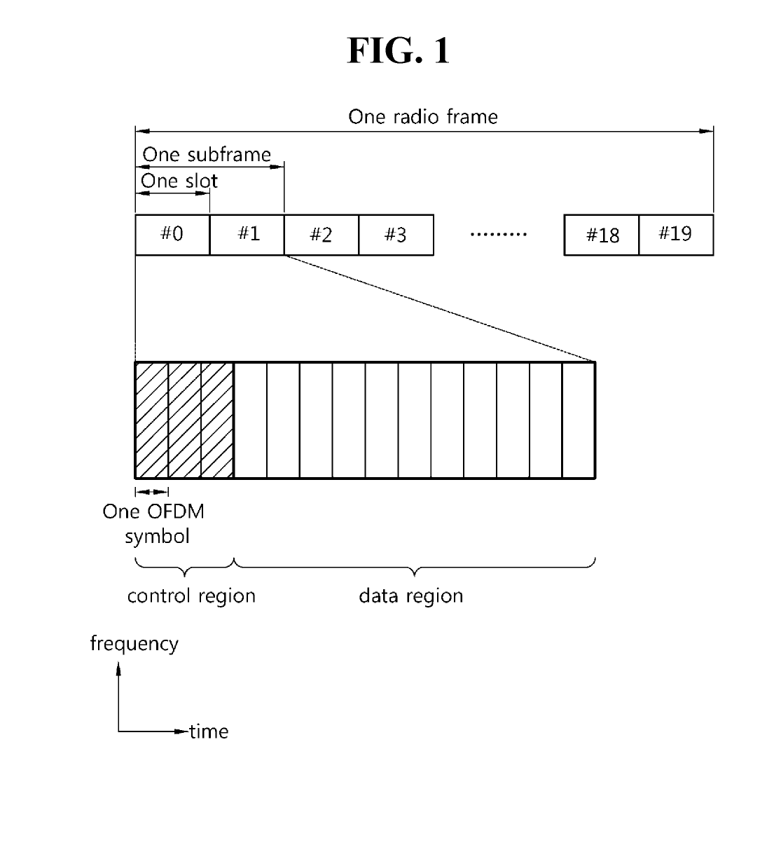

FIG. 1 illustrates the structure of a downlink radio frame in the 3GPP LTE. Section 6 of 3GPP TS 36.211 v8.7.0 (2009-05) “Evolved Universal Terrestrial Radio Access (E-UTRA): Physical Channels and Modulation (Release 8)” defines the structure of the downlink radio frame.

The radio frame is comprised of ten subframes indexed by 0 to 9. One subframe is comprised of two consecutive slots. A time required for transmitting one subframe is called TTI (transmission time interval). For example, the length of one subframe may be 1 ms and the length of one slot may be 0.5 ms.

One slot can include a plurality of OFDM (Orthogonal Frequency Division Multiplexing) symbols in the time domain. An OFDM symbol is introduced only to indicate a symbol period in the time domain, since the 3GPP LTE employs OFDMA (Orthogonal Frequency Division Multiple Access) for downlink (DL) transmission; therefore, it should be understood that introduction of the OFDM symbol does not limit application of a multiple access method, or how the method is named. For example, the OFDM symbol can be called differently as SC-FDMA (Single Carrier-Frequency Division Multiple Access) symbol, symbol interval, and many more.

It is assumed that a single slot includes seven OFDM symbols; however, the number of OFDM symbols included in a single slot can be changed according to the length of CP (Cyclic Prefix). According to the 3GPP TS 36.211 V8.7.0, in the case of a normal CP, a single slot includes seven OFDM symbols while a single slot includes six OFDM symbols in the case of an extended CP.

A resource block (RB) is the unit used for resource allocation, including a plurality of sub-carriers in one slot. For example, if it is the case that one slot includes seven OFDM symbols in the time domain and a resource block includes 12 sub-carriers in the frequency domain, one resource block can include 7×12 resource elements (REs).

A downlink (DL) subframe is divided into a control region and a data region in the time domain. The control region includes a maximum of four leading OFDM symbols in a first slot within the subframe, but the number of OFDM symbols included in the control region can be changed. PDCCH (Physical Downlink Control Channel) and other control channels are allocated to the control region while PDSCH is allocated to the data region.

As disclosed in the 3GPP TS 36.211 V8.7.0, physical control channels in the 3GPP LTE can be divided into PDSCH (Physical Downlink Shared Channel) and PUSCH (Physical Uplink Shared Channel); and control channels including PDCCH (Physical Downlink Control Channel), PCFICH (Physical Control Format Indicator Channel), PHICH (Physical Hybrid-ARQ Indicator Channel), and PUCCH (Physical Uplink Control Channel).

PCFICH, which is mapped to the first OFDM symbol of the subframe, carries CFI (Control Format Indicator) related to the number of OFDM symbols used for transmission of control channels within the subframe. A UE first receives CFI through the PCFICH and monitors the PDCCH.

Different from the PDCCH, the PCFICH does not use blind decoding, but it is transmitted through fixed PCFICH resources of the subframe.

PHICH carries an ACK (positive acknowledgement)/NACK (negative acknowledgement) signal used for an uplink (UL) HARQ (Hybrid Automatic Repeat Request) process. The ACK/NACK signal, which is associated with UL (uplink) data transmission performed by the UE through PUSCH, is transmitted through the PHICH.

PBCH (Physical Broadcast Channel) is transmitted by four leading OFDM symbols of the second slot in the first subframe of a radio frame. The PBCH carries system information essential for a UE to communicate with a base station. The system information transmitted through the PBCH is called MIB (Master Information Block). Meanwhile, the system information transmitted through the PDSCH, designated by the PDCCH, is called SIB (System Information Block).

The control information carried through the PDCCH is called downlink control information (DCI). The DCI can include resource allocation of the PDSCH (which is also called DL grant), resource allocation of PUSCH (which is also called UL grant), and a set of transmission power control commands for individual UEs within an arbitrary UE group and/or activation of VoIP (Voice over Internet Protocol).

In the 3GPP LTE, blind decoding is used for detection of PDCCH. Blind decoding demasks CRC bits of PDCCH (which is called a candidate PDCCH) for a desired identifier and checks CRC error to confirm whether the corresponding PDCCH is a control channel to be employed.

The base station determines a PDCCH format according to the DCI to be sent to the UE, attaches CRC (Cyclic Redundancy Check) bits to the DCI, and masks the CRC bits with a unique identifier (which is called a radio network temporary identifier (RNTI)) according to the owner or intended use of the PDCCH.

The control region within the subframe includes a plurality of CCEs (Control Channel Elements). The CCE is a logical allocation unit used for providing an encoding rate according to the conditions of a wireless channel and corresponds to a plurality of REGs (Resource Element Groups). An REG includes a plurality of resource elements. According to a relationship between the number of CCEs and the encoding rate provided by the CCEs, format of the PDCCH and the number of available bits of the PDCCH are determined.

One REG comprises four REs, and one CCE comprises nine REGs. To establish a single PDCCH, {1, 2, 4, 8} CCEs can be used, where the individual {1, 2, 4, 8} elements is called CCE aggregation level.

The base station determines the number of CCEs used for transmission of PDDCH by considering channel conditions. For example, a single CCE may be sufficient for PDCCH transmission for a wireless device in a superior downlink channel condition. For a UE in a poor downlink channel condition, eight CCEs may be used for PDCCH transmission.

A control channel comprised of one or more CCEs performs interleaving in units of REGs, and is mapped to physical resources after cyclic shift based on cell identifiers is carried out.

Transmission of DL transmission blocks in the 3GPP LTE is carried out by a pair of PDCCH and PDSCH. Transmission of UL transmission blocks is carried out by a pair of PDCCH and PUSCH. For example, a UE receives DL transmission blocks through the PDSCH which is designated by the PDCCH. The UE monitors the PDCCH in the DL subframe, and receives DL resource allocation through the PDCCH. The UE receives DL transmission blocks through the PDSCH which is designated by the DL resource allocation.

In what follows, a multiple carrier system will be described.

The 3GPP LTE system supports the case where downlink bandwidth is different from uplink bandwidth, which, however, assumes that a single component carrier (CC) is employed. In the 3GPP LTE system, bandwidth of up to 20 MHz is supported and uplink bandwidth can be made different from downlink bandwidth. However, only one CC is supported for each of uplink and downlink transmission.

Spectrum aggregation (which is also called bandwidth aggregation or carrier aggregation) supports multiple CCs. For example, if five CCs are allocated for granularity of a carrier unit having bandwidth of 20 MHz, a maximum bandwidth of 100 MHz can be supported.

A single DL CC or a pair of UL CC and DL CC can correspond to a single cell. Therefore, a UE communicating with a base station through a plurality of DL CCs can be regarded to receive a service from a plurality of serving cells.

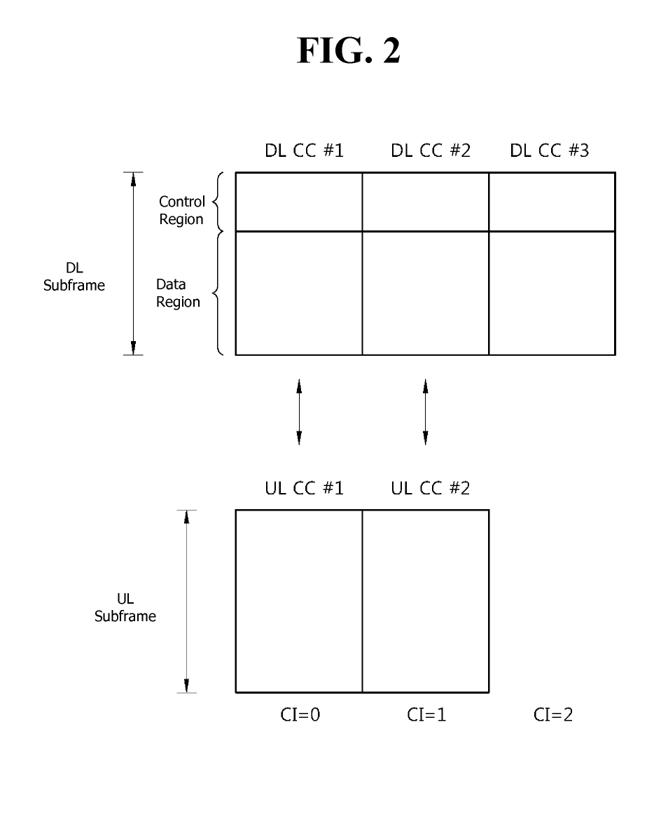

FIG. 2 illustrates one example of multiple carrier waves.

Although the example assumes three DL CCs and three UL CCs respectively, the number of DL CCs and UL CCs are not limited to the above assumption. At each DL CC, the PDCCH and the PDSCH are transmitted independently of each other, and each UL CC transmits the PUCCH and PUSCH independently of each other. Since three pairs of DL CCs and UL CCs are defined, the UE can be regarded to receive a service from three serving cells.

The UE can monitor the PDCCH through a plurality of DL CCs, and at the same time, can receive a DL transmission block through a plurality of DL CCs. The UE can transmit a plurality of UL transmission blocks simultaneously through a plurality of UL CCs.

Suppose a pair of DL CC #1 and UL CC #1 is a first serving cell; a pair of DL CC #2 and UL CC #2 is a second serving cell; and DL CC #3 is a third serving cell. Each serving cell can be identified through a cell index (CI). The CI can be defined uniquely within a cell or can be defined in a UE-specific manner. In this example, CI is assumed to be 0, 1, and 2 for the first to third serving cell, respectively.

A serving cell can be divided into a primary cell and a secondary cell. The primary cell is a cell that operates in a primary frequency and more particularly, a cell in which the UE performs an initial connection establishment procedure or a connection re-establishment procedure; or a cell indicated as a primary cell during a handover process. The secondary cell is a cell that operates in a secondary frequency, which is configured once RRC connection is established and used to provide additional radio resources. At least one primary cell is always set up while the secondary cell can be added/modified/released by upper layer signaling (for example, RRC message).

CI of the primary cell can be fixed. For example, the lowest CI can be used as the CI of the primary cell. In what follows, it is assumed that CI of the primary cell is 0 while a number starting from 1 is assigned sequentially to the CI of the secondary cell.

The UE can monitor PDCCH through a plurality of serving cells. However, even if N serving cells are actually available, the base station can be configured to monitor PDCCH of M serving cells (M≦N). Also, the base station can be configured to monitor PDCCH first of all for L (L≦M≦N) serving cells.

In a multiple carrier system, two CC scheduling methods can be used.

According to the first method of per-CC scheduling, PDSCH scheduling is performed only within each serving cell. PDCCH of the primary cell performs scheduling of PDSCH of the primary cell while PDCCH of the secondary cell performs scheduling of the secondary cell. Accordingly, the PDCCH-PDSCH structure of the existing 3GPP LTE can be used without modification.

According to the second method of cross-CC scheduling, PDCCH of each serving cell can not only perform scheduling of its PDDSCH but also perform scheduling PDSCH of other serving cells.

A serving cell to which PDCCH is transmitted is called a scheduling cell; a serving cell to which PDSCH scheduled through the PDCCH of the scheduling cell is called a scheduled cell. The scheduling cell can be called a scheduling CC while the scheduled cell can be called a scheduled CC. According to the per-CC scheduling, the scheduling cell and the scheduled cell are the same. According to the cross-CC scheduling, the scheduling cell and the scheduled cell can be the same or different from each other.

For cross-CC scheduling, CIF (Carrier Indicator Field) is being introduced into the DCI. The CIF includes CI of the cell having PDSCH to be scheduled. It can be regarded that CIF indicates CI of a scheduled cell. According to per-CC scheduling, CIF is not included in the DCI of PDCCH. According to cross-CC scheduling, CIF is included in the DCI of PDCCH.

The base station can configure per-CC scheduling or cross-CC scheduling in a cell-specific or UE-specific manner. For example, the base station can configure a particular UE with the cross-CC scheduling by using a upper layer message such as RRC message.

Even in the case of a plurality of serving cells, the base station can be made to monitor PDCCH only in a particular serving cell to reduce a load due to blind decoding. A cell activated to monitor the PDCCH is called an activated cell (or monitoring cell).

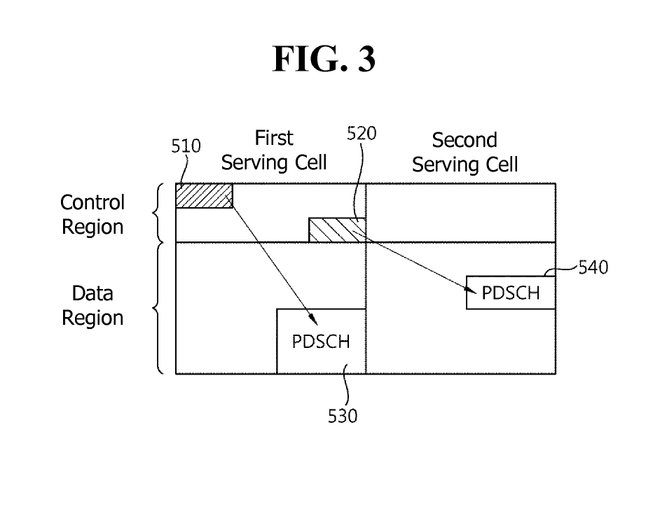

FIG. 3 illustrates one example of cross-CC scheduling.

The UE detects PDCCH 510. And the UE receives a DL transmission block on the PDSCH 530 based on the DCI on the PDCCH 510. Even if cross-CC scheduling is employed, a PDCCH-PDSCH pair within the same cell can still be used.

The UE detects PDCCH 520. Suppose CIF within DCI of the PDCCH 520 indicates a second serving cell. The UE receives a DL transmission block on the PDSCH 540 of the second serving cell.

Now maintaining uplink time alignment in the 3GPP LTE will be described.

To reduce interference among UEs, the base station performs scheduling for uplink signals transmitted by the UEs within the cell to be received within the respective time boundaries. Such scheduling is called time alignment maintenance.

The random access process is one of methods for managing time alignment. The UE transmits a random access preamble to the base station. The base station calculates a time alignment value based on the received random access preamble, by which transmission timing of the UE is made fast or slow. And the base station transmits a random access response including the calculated time alignment value. The UE updates the transmission timing by using the time alignment value.

The information indicating the time alignment value sent to the UE by the base station to maintain uplink time alignment is called TAC (Timing Advance Command).

In another method for managing time alignment, the base station receives a sounding reference signal periodically or aperiodically from the UE; calculates a time alignment value of the UE through the sounding reference signal; and informs the UE of the calculated time alignment value in the form of MAC CE (Control Element) including the time alignment value, which is called TAO MAC CE.

Since UEs are mobile in general, transmission timing of a UE is changed according to the UE's speed and position. Therefore, it is preferable to understand that the time alignment value received by the UE is effective only for a predetermined time period. What is used for this purpose is time alignment timer.

If the UE receives a time alignment command from the base station and updates the time alignment value, the time alignment timer is commenced or resumed. The UE is able to perform uplink transmission only if the time alignment timer is in operation. The base station can inform the UE about the time alignment timer value through an RRC message such as system information or radio bearer reconfiguration message.

If the time alignment timer is terminated or does not operate, the UE assumes that time alignment with the base station is not successful; and allows no uplink signals except for the random access preamble to be transmitted.

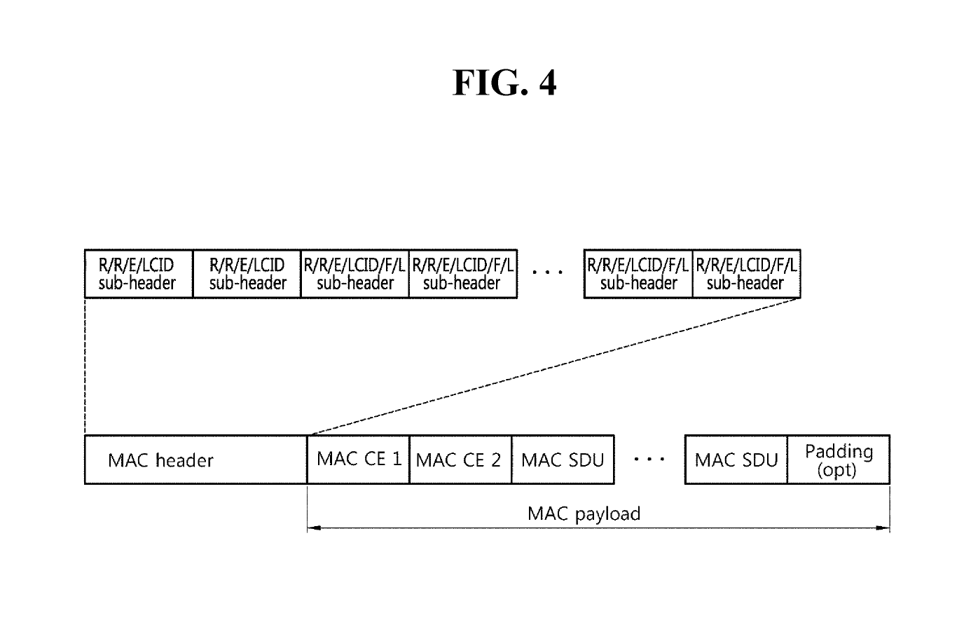

FIG. 4 illustrates the structure of MAC PDU in the 3GPP LTE.

An MAC (Medium Access Control) PDU (Protocol Data Unit) includes MAC header, MAC CE (control element), and at least one MAC SDU (Service Data Unit). The MAC header includes at least one sub-header; and each sub-header corresponds to the MAC CE and MAC SDU. The sub-header is used to represent lengths and properties of the MAC CE and MAC SDU. The MAC SDU is a data block originating from a upper layer (for example, RLC layer or RRC layer) of the MAC layer while the MAC CE is used to deliver control information of the MAC layer such as a buffer status report.

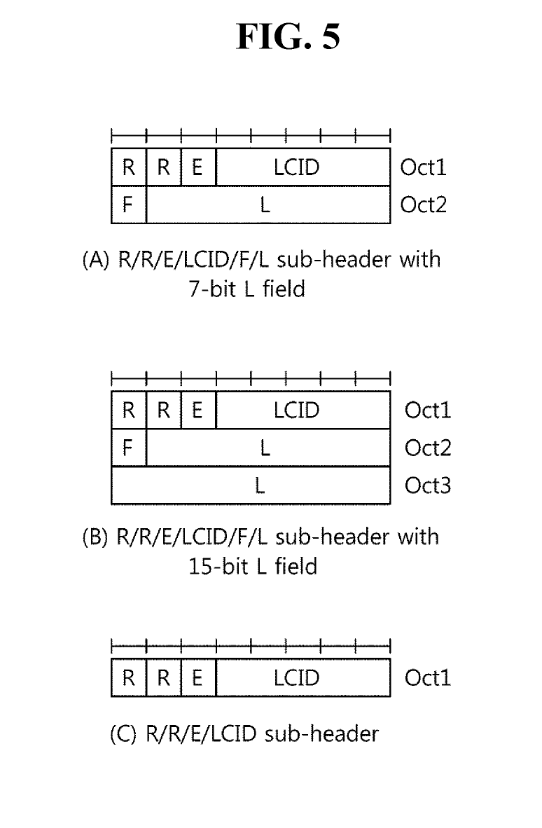

FIG. 5 illustrates various examples of MAC sub-header.

Description of each field is as follows.

R (1 bit): Reserved field

E (1 bit): Extension field. It informs whether F and L field exists next to the bit.

LCID (5 bit): Logical Channel ID field. It specifies a type of MAC CE a logical channel the MAC SDU belongs.

F (1 bit): Format field. This field informs whether the size of the next L field is 7 bit or 15 bit.

L (7 or 15 bit): Length field. This field informs the length of the MAC CE or the length of MAC SDU corresponding to the MAC sub-header.

F and L field are not included in the MAC sub-header corresponding to a fixed-sized MAC CE.

FIG. 5(A) and (B) are examples of MAC sub-header structures corresponding to variable-sized MAC CE and MAC SDU, and FIG. 5(C) is an example of an MAC sub-header structure corresponding to a fixed-sized MAC CE.

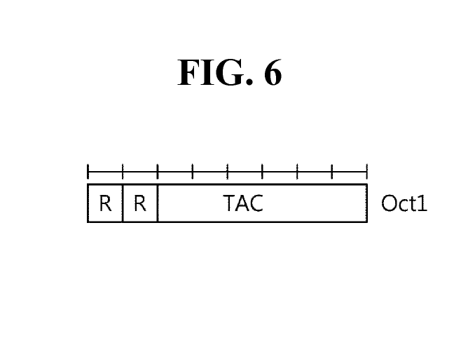

FIG. 6 illustrates TAC MAC CE. TAC is used for controlling the amount of time adjustment to be applied by the UE, where the size of the TAC field is 6 bits.

In the conventional 3GPP LTE system, a single TAC is used commonly even if a plurality of serving cells is employed. However, in a near future, a plurality of serving cells belonging to different frequency bands and exhibiting propagation characteristics different from each other can be set up for the UE. Also, these days, devices such as RRHs (Remote Radio Headers) are deployed in the cells to extend coverage or remove coverage holes.

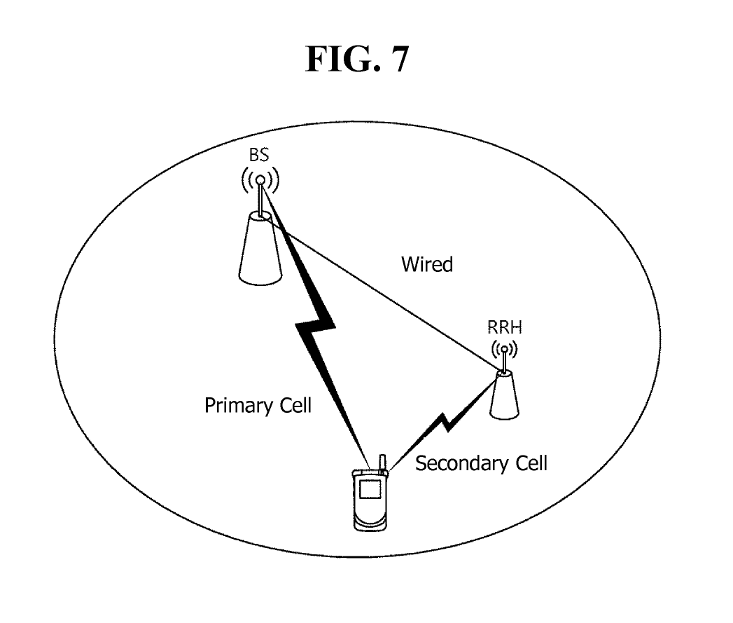

FIG. 7 illustrates a difference of UL propagation in a plurality of serving cells.

It is assumed that a primary cell is configured by a base station at a distant location while a secondary cell is configured by a nearby RRH.

Propagation delay in direct communication between a base station and a UE through a radio channel shows a significant difference from the propagation delay through RRH due to processing time of RRH and the like.

It is preferable to set up TAC for each serving cell if a plurality of serving cells exhibits propagation delay characteristics different from each other.

The present invention proposes a method for allocating multiple TACs to a UE, and a method for transmitting multiple TACs to the UE.

In the following, it is assumed that separate TACs are applied to serving cells different from each other, which can also be used to the case where separate TACs are applied to individual cell groups having one or multiple cells. The ‘cell’ to which TAC is applied may denote a ‘cell group’ to which separate TACs are applied. For example, a primary cell may denote a single primary cell; or a cell group comprising one primary cell and one or more secondary cells.

Cell groups can be classified by taking account of frequency band, propagation delay characteristics, and so on. For example, a cell group can include cells belonging to the same frequency band.

A base station can inform the UE of information about a cell group through an RRC message or the like.

The structure of the existing TAC MAC CE can be changed to transmit multiple TACs to the UE.

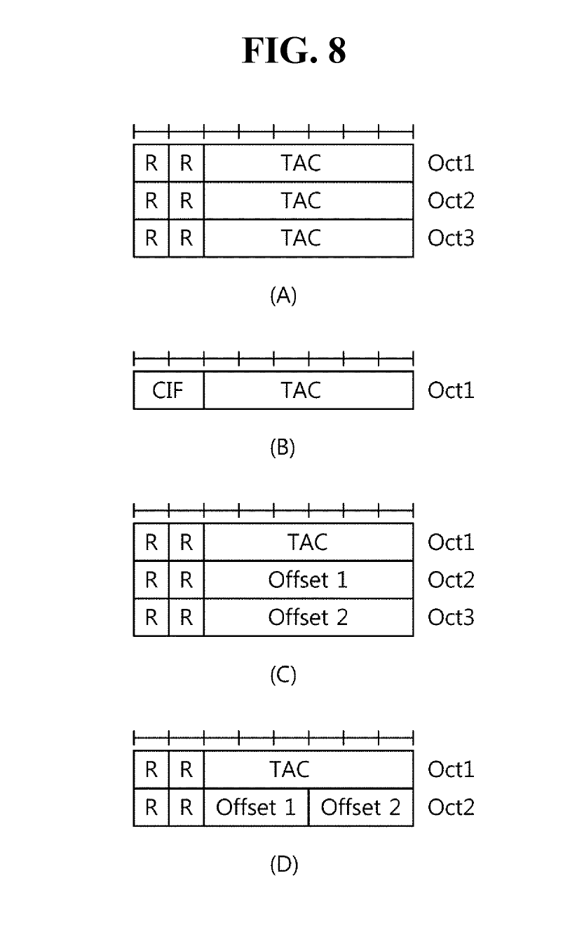

FIG. 8 illustrates examples of TAC MAC CE according to one embodiment of the present invention.

FIG. 8(A) illustrates TAC MAC CE which includes multiple TACs applied to the respective serving cells (or cell groups). Although three TACs are shown in the example, the number of TACs is not limited. The number of TACs included in the MAC CE is predefined, or the base station can inform the UE of the number of TACs.

FIG. 8(B) illustrates TAC MAC CE which includes CI field indicating a serving cell (or cell group) to which TAC is applied. The ‘R’ reserved in the example of FIG. 8(A) can be replaced with the CI field. If TAO is applied to the corresponding serving cell, the UE can start or resume a time alignment timer of the corresponding serving cell. Once the time alignment timer is terminated, the UE can deactivate the corresponding serving cell or release UL resources.

FIGS. 8(C) and (D) illustrate examples using offset values. TAC in the reference cell (for example, primary cell) is delivered without modification whereas TACs in the two remaining cells include an offset in the MAC CE with respect to the TAC of the reference cell. The number of the remaining cells is only an example for illustration. In the example of FIG. 8(C), the offset size is 8 bits while it is 4 bits in the example of FIG. 8(D). The examples of FIGS. 8(C) and (D) offer an advantage that they re-use the existing field structure while the range of TAC for the remaining cells can be extended.

In case differences between UL transmission timing of a particular cell (for example, the primary cell) and those of other cells exceed a threshold while the UE is capable, of receiving multiple TACs, a method for limiting UL transmission may be taken into consideration. This is so because the UE may develop a malfunction as a timing relationship between UL and DL transmission is not kept consistent if transmission timings between cells are excessively out of synchronization.

Information about the threshold can be predefined, or the base station can inform the UE of the information about the threshold. If differences between UL transmission timings of cells exceed a threshold, the UE may abandon transmission of a particular UL physical channel (for example, PUSCH, PUCCH, SRS, RACH, and the like). For example, if a difference between the UL transmission timings of the primary and secondary cell exceeds a threshold, UL transmission of the secondary cell can be dropped.

UL transmission can be applied restrictively only to the case where the UE operates in TDD (Time Division Duplex) mode. Similarly, UL transmission can be applied restrictively to the case where the UL is configured for cross-CC scheduling.

The UE can inform the base station of timing information to let the base station detect a UL transmission timing difference of the UE. As a specific example, the timing information can include at least one of the following items:

a) relative UL transmission timing difference of a serving cell to a reference serving cell (e.g., primary cell),

b) relative UL transmission timing difference between a pair of serving cells,

c) difference between DL reception timing of a first serving cell and UL transmission timing of a second serving cell,

d) difference between DL reception timing of a reference serving cell (e.g., primary cell) and UL transmission timing of a serving cell,

e) relative DL reception timing difference of a serving cell to a reference serving cell (e.g., primary cell),

f) relative DL transmission timing difference between a pair of serving cells, and

g) indication of exceeding a threshold of UL timing difference between two serving cells.

The timing information can be transmitted through RRC message, MAC message, or PDCCH. Transmission of the timing information can be triggered by at least one of the following events:

i) a periodic method, where the period is predetermined or set up by the base station;

ii) the case where UL transmission timing difference exceeds a threshold or a predetermined time period is passed after last timing information is transmitted; and

iii) a request from the base station, where the request can be transmitted through RRC message, MAC message, or PDCCH.

In what follows, described will be a method for performing a random access process proposed to receive TAC while a plurality of serving cells are configured.

A random access process is used for acquiring UL synchronization between a UE and a base station; or allocating UL radio resources to the UE. After power is turned on, the UE acquires downlink synchronization with an initial cell and receives system information. And from the system information, the UE obtains information about a set of available random access preambles and resources used for transmission of random access preambles. The UE transmits a random access preamble selected arbitrarily from the set of random access preambles, and the base station which has received the random access preamble transmits TAC for uplink synchronization to the UE through a random access response.

The conventional random access process assumes that it operates in a single cell. In other words, the random access preamble is limited to be transmitted only from the primary cell. However, as multiple serving cells are employed and a transmission timing difference is developed, it becomes necessary to consider transmitting the random access preamble also from the secondary cell to receive the TAC.

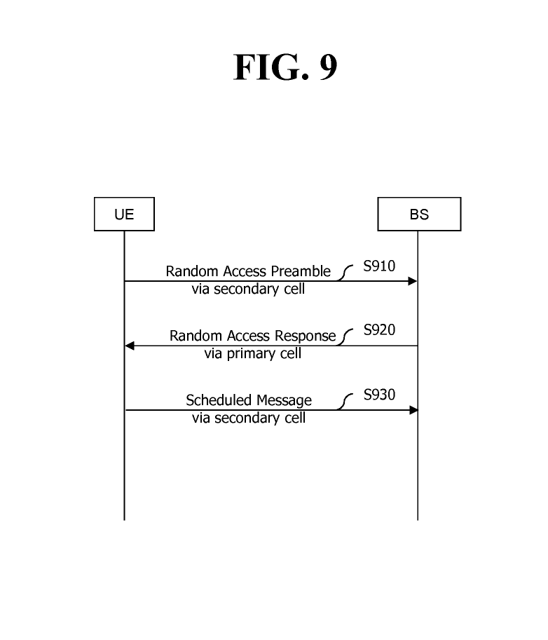

FIG. 9 illustrates a random access process according to one embodiment of the present invention. Although FIG. 9 assumes a situation where a random access preamble is transmitted from the primary cell and a random access response is transmitted from the secondary cell, it can be generalized to the case where the random access preamble and the random access response are transmitted from the cells different from those in the example.

The UE transmits a random access preamble to the secondary cell S910.

The UE receives a random access response from the primary cell S920. The random access response is detected through two stages. First, the UE detects PDCCH masked by RA-RNTI (Random Access-RNTI) in the primary cell. Then the UE receives a random access response within MAC PDU through PDSCH indicated by DL grant on the detected PDCCH. According to whether cross-cc scheduling is applied, the PDSCH can be transmitted from the primary or secondary cell. In other words, if cross-cc scheduling is employed, the PDCCH is detected in the primary cell, and the random access response is received through PDSCH of the cell indicated by CIF within the PDCCH.

The random access response can include TAC, UL grant, and temporary C-RNTI.

The UE applies the received TAC to the secondary cell and transmits a message scheduled according to the UL grant within the random access response to the secondary cell S930.

When the UE receives a random access response through the primary cell after the UE transmits a random access preamble through the secondary cell, it is necessary to distinguish whether the corresponding random access response is obtained in response to transmission of random access frame by the primary cell or transmission of random access frame by the secondary cell.

The UE can apply TAC of the corresponding random access response to an identified serving cell.

In one embodiment, the random access response can include CIF indicating a serving cell which has received a random access preamble. For example, if the random access response is received by the primary cell and CIF of the random access response indicates the secondary cell, the UE can confirm that the random access response corresponds to a response for the random access preamble transmitted by the secondary cell. The size of the CIF can be 3 bits. On the other hand, the CIF may not be included directly in the random access response, but it can be included indirectly in a CRC (Cyclic Redundancy Check) masking code or a scrambling code of PDCCH which schedules the random access response, thus indicating the corresponding Cl. The UE can transmit a scheduled message to the serving cell indicated by CIF within the random access response.

In another embodiment, different RA-RNTIs can be allocated to the respective serving cells. For example, suppose a first RA-RNTI is allocated to the primary cell and a second RA-RNTI is allocated to the secondary cell. If the UE detects PDCCH masked by the second RA-RNTI in the primary cell after the secondary cell transmits a random access preamble, the UE can confirm that the detected PDCCH is a random access response for transmission of the random access preamble by the secondary cell.

In a yet another embodiment, the random access response can be divided according to search space of PDCCH. If the random access preamble is configured to be transmitted in a certain UL CC, detection of PDCCH masked with RA-RNTI can be attempted in the common search space of DL CC paired with the corresponding UL CC. The random access response of a particular DL CC may imply a response for the random access preamble transmitted to an UL CC paired with the corresponding DL CC. The corresponding random access response can be received without additional signaling such as CIF or additional allocation of RA-RNTI.

In a still another embodiment, if the random access preamble is transmitted through an UL CC of the secondary cell, detection of PDCCH which schedules the random access response can be attempted in the UE-specific search space allocated for scheduling PDSCH (and/or PUSCH) of the secondary cell. The UE can distinguish which cell transmits the random access preamble that generates a received random access response, according to the UE-specific search space in which PDCCH scheduling the random access response is detected. This function can be applied both for cross-CC scheduling where PDCCH scheduling the random access response for multiple cells is transmitted from a single cell, and per-CC scheduling where PDCCH scheduling the random access response for individual cells is scheduled by each of the cells. In the case of cross-CC scheduling, which cell transmits the random access preamble that generates the response can be identified based on CIF included in the PDCCH scheduling the random access response.

In a further embodiment, the random access preamble and/or random access resources transmitted from each cell can be made different from each other. For example, the primary cell can select the random access preamble from a first set while the secondary cell can select the random access preamble in a second set. The UE, by receiving the random access response having an identifier of the corresponding random access preamble, can identify which cell has transmitted the random access preamble that generates the response. On the other hand, a time point at which the random access preamble is transmitted (namely, subframe) can be made different for each cell. According to Section 5.7 of the 3GPP TS 36.211 V8.9.0 (2009-12), the subframe through which a random access preamble is transmitted varies according to PRACH configuration index. If it is assumed that three subframes are able to transmit the random access preamble, the primary cell transmits two subframes while the secondary cell transmits the remaining subframe.

To remove ambiguity in determining a cell transmitting the random access preamble that generates a random access response, a time period during which the random access preamble is transmitted can be limited. In other words, the above restriction is made to prevent overlap of processes for receiving random access responses while different cells transmit the respective random access preambles. The random access process can be made to be performed one at a time.

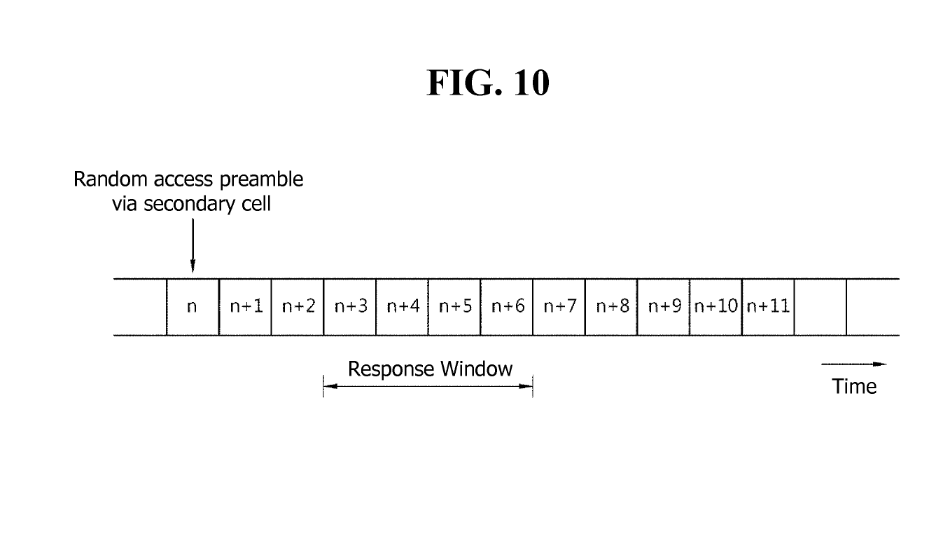

FIG. 10 illustrates one example of performing a random access process.

Suppose a random access preamble is transmitted from a subframe n through the secondary cell. The UE monitors PDCCH for a random access response in the response windows starting three subframes away from the subframe through which the random access preamble is transmitted. At this time, the size of response windows is 4 subframes, but it is so determined only for illustrative purpose. Therefore the UE monitors PDCCH masked by RA-RNTI from subframe n+3 to n+6.

To prevent overlap of the random access process, transmission of the random access preamble of the primary cell is prohibited for subframe n, n+1, and n+2. In other words, transmission of the random access preamble of the primary cell is allowed for subframes starting from n+3. If the subframe n+3 transmits the random access preamble of the primary cell, the UE monitors PDCCH for random access response from and after subframe n+7. As another example, the random access preamble of the primary cell can be configured to be transmitted from and after subframe n+7 at which the previous response windows end.

To transmit the random access preamble of the primary cell to subframe n, n+1, and n+2, the random access process in the secondary cell can be suspended. For example, suppose the subframe n transmits a random access preamble through the secondary cell and the UE attempts to transmit a random access preamble from subframe n+2 through the primary cell. The UE then suspends the random access process for the secondary cell and transmits the random access preamble from the subframe n+2 through the primary cell. The UE can perform PDCCH monitoring for receiving a random access response for the random access preamble of the primary cell from and after subframe n+5.

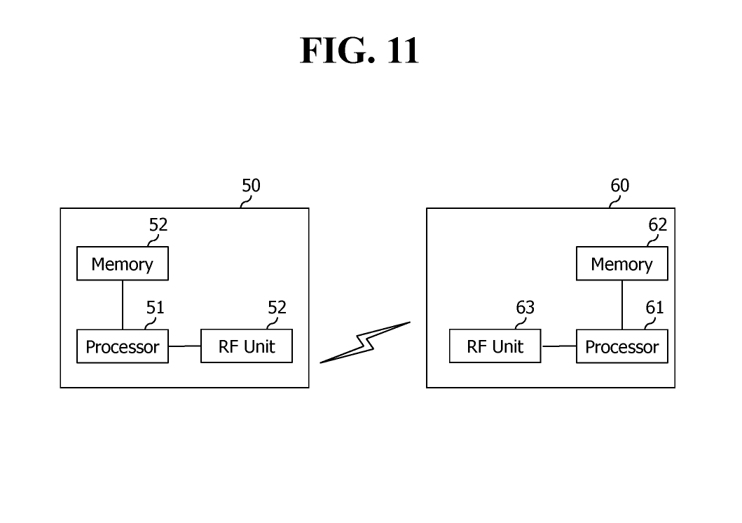

FIG. 11 illustrates a block diagram of a wireless communication system in which an embodiment of the present invention is implemented.

The base station 50 comprises a processor 51, a memory 52, and an RF (Radio Frequency) unit 53. The memory 52, being connected to the processor 51, stores various kinds of information for driving the processor 51. The RF unit 53, being connected to the processor 51, transmits and/or receives radio signals. The processor 51 embodies the proposed functions, processes, and/or methods. In the embodiment above, the operation of the base station can be realized by the processor 51.

The UE 60 comprises a processor 61, a memory 62, and an RF (Radio Frequency) unit 63. The memory 62, being connected to the processor 61, stores various kinds of information for driving the processor 61. The RF unit 63, being connected to the processor 61, transmits and/or receives radio signals. The processor 61 embodies the proposed functions, processes, and/or methods. In the embodiment above, the operation of the UE can be realized by the processor 61.

The processor may include Application-Specific Integrated Circuits (ASICs), other chipsets, logic circuits, and/or data processing devices. The memory may include Read-Only Memory (ROM), Random Access Memory (RAM), flash memory, memory cards, storage media, and/or other storage devices. The RF unit may include a baseband circuit for processing radio signals. When the above-described embodiment is implemented in software, the above-described scheme may be embodied using a module (process or function) that performs the above function. The module may be stored in the memory and executed by the processor. The memory may be placed inside or outside the processor and may be connected to the processor using a variety of well-known means.

In the exemplary system above, methods have been described based on a flow diagram in the form of a series of stages or blocks, but the present invention is not limited by the order of the stages; some stage can be performed with other stages in a different order, or can be performed simultaneously. Also, it should be clearly understood by those skilled in the art that the stages illustrated in the flow diagram are not exclusive; another stage can be included; and one or more stages of the flow diagram can be removed without affecting the technical scope of the present invention.

1. A method for performing a random access procedure in a wireless communication system, a method comprising:
transmitting a random access preamble for a first serving cell;
monitoring a control channel for receiving a random access response with respect to the random access preamble via a second serving cell; and
receiving the random access response with respect to the random access preamble from the second serving cell.

2. The method of claim 1, wherein a transmission of a random access preamble to the second serving cell is prohibited while the control channel is being monitored.

3. The method of claim 2, further comprising suspending monitoring the control channel to transmit a random access preamble to the second serving cell while the control channel is being monitored.

4. The method of claim 1, wherein the random access response further includes uplink grant.

5. The method of claim 4, further comprising transmitting a message scheduled according to the uplink grant.

6. The method of claim 1, wherein the first serving cell is a secondary cell while the second serving cell is a primary cell.

7. The method of claim 1, wherein the random access response includes TAC (Timing Advance Command) for uplink time alignment.

8. The method of claim 7, wherein the TAC is applied to the first serving cell.

9. An apparatus for performing a random access procedure in a wireless communication system, the apparatus comprising:
an RF (Radio Frequency) unit transmitting and receiving radio signals; and
a processor connected to the RF unit and configured to instruct the RF unit to
transmit a random access preamble for a first serving cell;
monitor a control channel for receiving a random access response with respect to the random access preamble via a second serving cell; and
receive the random access response with respect to the random access preamble from the second serving cell.

10. The apparatus of claim 9, wherein a transmission of a random access preamble to the second serving cell is prohibited while the control channel is being monitored.

11. The apparatus of claim 9, wherein monitoring of the control channel is suspended to transmit a random access preamble to the second serving cell while the control channel is being monitored.

12. The apparatus of claim 9, wherein the random access response further includes uplink grant.

13. The apparatus of claim 12, wherein the processor commands the RF unit to transmit a message scheduled according to the uplink grant.

14. The apparatus of claim 9, wherein the first serving cell is a secondary cell while the second serving cell is a primary cell.

15. The apparatus of claim 9, wherein the random access response includes TAC (Timing Advance Command) for uplink time alignment and the apparatus of claim 7, wherein the TAC is applied to the first serving cell.
